(19) United States
(12) Patent Application Publication
(10) Pub. No.: US 2026/0005844 A1
(43) Pub. Date: Jan. 1, 2026

(54) SERVICE DATA PROCESSING METHOD

(71) Applicant: TENCENT TECHNOLOGY (SHENZHEN) COMPANY LIMITED, Shenzhen (CN)

(72) Inventors: Qi CUI, Shenzhen (CN); Zhiqiang ZHANG, Shenzhen (CN); Zhuang ZHANG, Shenzhen (CN); Shaoming WANG, Shenzhen (CN); Runzeng GUO, Shenzhen (CN); Jinkun HOU, Shenzhen (CN)

(73) Assignee: TENCENT TECHNOLOGY (SHENZHEN) COMPANY LIMITED, Shenzhen (CN)

(21) Appl. No.: 19/319,523

(22) Filed: Sep. 4, 2025

Related U.S. Application Data
(63) Continuation of application No. PCT/CN2024/096736, filed on May 31, 2024.

(30) Foreign Application Priority Data
Jun. 19, 2023 (CN) 202310732172.7

(51) Int. Cl. H04L 9/08; H04L 9/14; H04L 9/32

(52) U.S. Cl. CPC H04L 9/0861; H04L 9/0894; H04L 9/14; H04L 9/3231

(57) ABSTRACT

In a data processing method, in response to a trigger event of a target service, service data corresponding to the target service is obtained. An encryption key corresponding to the target service is obtained. The encryption key is generated by a server of the target service by encrypting a dynamically generated service key based on a pre-stored first root key. Based on a pre-stored second root key, the encryption key is decrypted to obtain the service key. The first root key and the second root key form a set of symmetric keys. The service data is encrypted based on the service key to generate intermediate data. The intermediate data is transmitted to the server. An execution result generated by the server based on the service data is received, The server decrypts the intermediate data based on the service key to obtain the service data.

### RELATED APPLICATIONS

The present application is a continuation of International Application No. PCT/CN2024/096736, filed on May 31, 2024, which claims priority to Chinese Patent Application No. 202310732172.7, filed on Jun. 19, 2023. The entire disclosures of the prior applications are hereby incorporated by reference.

### FIELD OF THE TECHNOLOGY

This disclosure relates to the field of computer technologies, including to data processing.

### BACKGROUND OF THE DISCLOSURE

Currently, when a user performs payment through a third-party application in a terminal device such as a mobile phone or a computer, or opens a private file or an application in a terminal device such as a mobile phone or a computer, biological authentication information such as a face or a fingerprint usually needs to be authenticated through a security authentication technology, to authenticate a user identity. For example, a third-party application client may transmit the biological authentication information to a corresponding application server for verification, so that after the application server verifies that the biological authentication information is legal, functions such as payment and opening a private file or an application are implemented.

Currently, to improve security of the biological authentication information, a trusted application (TA) in a secure area (trusted execution environment, TEE) of the terminal device may sign the biological authentication information obtained by a third-party application, and then perform information verification through the application server corresponding to the third-party application. However, when the third-party application exchanges data with the TA, an interface of an application framework layer in a terminal system usually needs to be passed through. In this case, the third-party application needs to define an interface function of the application framework layer, so that a redefined new interface may execute a corresponding algorithm to call a hardware abstraction layer, thereby accessing the TA in the TEE. However, the foregoing solution needs to be frequently updated along with the application framework layer in the system. In other words, device adaptation needs to be performed on a hardware layer, causing the solution to be not universal.

Therefore, a universal and secure service data processing method is urgently needed currently.

### SUMMARY

Aspects of this disclosure provide a data processing method and apparatus, a device, and a storage medium, which are configured for securely and universally implementing service data processing.

According to an aspect of the disclosure, a data processing method is provided. In the method, in response to a trigger event of a target service, service data corresponding to the target service is obtained. An encryption key corresponding to the target service is obtained. The encryption key is generated by a server of the target service by encrypting a dynamically generated service key based on a pre-stored first root key. Based on a pre-stored second root key, the encryption key is decrypted to obtain the service key. The first root key and the second root key form a set of symmetric keys. The service data is encrypted based on the service key to generate intermediate data. The intermediate data is transmitted to the server. An execution result generated by the server based on the service data is received, the server decrypts the intermediate data based on the service key to obtain the service data.

According to an aspect of the present disclosure, a data processing apparatus is provided. The data processing apparatus includes processing circuitry configured to obtain, in response to a trigger event of a target service, service data corresponding to the target service. The processing circuitry is configured to obtain an encryption key corresponding to the target service, the encryption key being generated by a server of the target service by encrypting a dynamically generated service key based on a pre-stored first root key. The processing circuitry is configured to decrypt, based on a pre-stored second root key, the encryption key to obtain the service key. The first root key and the second root key form a set of symmetric keys. The processing circuitry is configured to encrypt the service data based on the service key to generate intermediate data. The processing circuitry is configured to transmit the intermediate data to the server. The processing circuitry is configured to receive an execution result generated by the server based on the service data, wherein the server decrypts the intermediate data based on the service key to obtain the service data.

According to an aspect of the present disclosure, a non-transitory computer-readable storage medium is disclosed. The non-transitory computer-readable storage medium stores instructions which, when executed by a processor, cause the processor to perform the data processing method.

In view of the above, according to an aspect of this disclosure, a data processing method is provided, including: obtaining service data corresponding to a target service; obtaining an encryption key corresponding to the target service, the encryption key being generated by a background server of the target service by encrypting a service key through a pre-stored first root key, the service key being dynamically generated by the background server; calling a pre-stored second root key to decrypt the encryption key to obtain the service key, the first root key and the second root key being a set of symmetric keys; encrypting the service data through the service key to obtain intermediate data; transmitting the intermediate data to the background server; and receiving an execution result of the target service, the execution result being obtained by the background server by executing the target service based on the service data, and the service data being obtained by the background server by decrypting the intermediate data through the service key.

According to another aspect of this disclosure, a data processing apparatus is provided, including: an obtaining module, configured to obtain service data corresponding to a target service; a processing module, configured to: obtain an encryption key corresponding to the target service, the encryption key being generated by a background server of the target service by encrypting a service key through a pre-stored first root key, the service key being dynamically generated by the background server; call a pre-stored second root key to decrypt the encryption key to obtain the service key, the first root key and the second root key being a set of symmetric keys; and encrypt the service data through the service key to obtain intermediate data; and a transceiving module, configured to transmit the intermediate data to the background server, and receive an execution result of the target service, the execution result being obtained by the background server by executing the target service based on the service data, and the service data being obtained by the background server by decrypting the intermediate data through the service key.

According to another aspect of this disclosure, a computer device is provided, including a memory, a processor, and a bus system, the memory being configured to store a program, the processor being configured to execute a computer program in the memory, and the processor being configured to perform the method in the above aspects based on the computer program, and the bus system being configured to connect to the memory and the processor, to cause the memory and the processor to communicate with each other.

According to another aspect of this disclosure, a computer-readable storage medium is provided, having a computer program stored therein, the computer program, when run on a computer, causing the computer to perform the method in the above aspects.

According to another aspect of this disclosure, a computer program product including a computer program is provided, the computer program, when run on a computer, causing the computer to perform the method in the above aspects.

It may be learned from the above technical solutions that the aspects of this disclosure have the following advantages. The service key corresponding to the service data is encrypted and decrypted through a root key for transmission, and the service data is also encrypted and transmitted through the service key. As a result, security of the service data in a transmission process can be ensured.

Further, the encryption processing process of the service key is independently run in the encryption protection system, so that the service key can be securely stored and obtained. The encryption protection system does not need to exchange information with the background server. Therefore, configuration is not required for different background servers, which causes an entire data processing process to be applicable to various scenarios.

### BRIEF DESCRIPTION OF THE DRAWINGS

FIG. 1a is a schematic diagram of comparison between effects of a virtual machine protection (VMP) scheme from a perspective of an attacker and the related art according to an aspect of this disclosure.

FIG. 1b is a system schematic diagram of a compilation process and an operation process of a VMP scheme according to an aspect of this disclosure.

FIG. 2a is a schematic architectural diagram of an application scenario of a data processing method according to an aspect of this disclosure.

FIG. 2b is a schematic diagram of a system architecture of a data processing method according to an aspect of this disclosure.

FIG. 3 is a schematic diagram of an embodiment of a data processing method according to an aspect of this disclosure.

FIG. 4 is a schematic flowchart of an application scenario of a data processing method according to an aspect of this disclosure.

FIG. 5 is a schematic diagram of an embodiment of a data processing apparatus according to an aspect of this disclosure.

FIG. 6 is a schematic diagram of another embodiment of a data processing apparatus according to an aspect of this disclosure.

FIG. 7 is a schematic diagram of another embodiment of a data processing apparatus according to an aspect of this disclosure.

### DESCRIPTION OF EMBODIMENTS

Aspects of this disclosure provide a data processing method and apparatus, a device, and a storage medium, which are configured for securely and universally implementing service data processing.

The terms such as “first”, “second”, “third”, and “fourth” (if any) in the specification and claims of this disclosure and in the accompanying drawings are configured for distinguishing similar objects and not necessarily configured for describing any particular order or sequence. Data used in this way may be transposed where appropriate, so that the aspects of this disclosure described herein may be, for example, implemented in an order different from the order shown or described herein. In addition, the terms “include”, “corresponding to” and any other variants are intended to cover the non-exclusive inclusion. For example, a process, a method, a system, a product, or a device that includes a series of operations or units is not necessarily limited to those expressly listed operations or units, but may include other operations or units not expressly listed or inherent to such a process, a method, a product, or a device.

Currently, when a user performs payment through a third-party application in a terminal device such as a mobile phone or a computer, or opens a private file or an application in a terminal device such as a mobile phone or a computer, biological authentication information such as a face or a fingerprint usually needs to be authenticated through a security authentication technology, to authenticate a user identity. In the related art, frequent update along with an application framework layer in a system is needed. In other words, device adaptation needs to be performed on a hardware layer, causing the solution to be not universal. Alternatively, a key of the biological authentication information is written into a code or stored in a storage area of the terminal device, but the key has a relatively low security level, affecting security of service data. Therefore, a universal and secure service data processing method is urgently needed currently.

To resolve the foregoing technical problem, this disclosure provides the following technical solutions: obtaining service data corresponding to a target service; obtaining an encryption key corresponding to the target service from a key management library, the encryption key being generated by a background server of the target service by encrypting a service key through a pre-stored first root key, the service key being dynamically generated by the background server; calling an encryption protection system, and decrypting the encryption key through a pre-stored second root key to obtain the service key, the first root key and the second root key being a set of symmetric keys; encrypting the service data through the service key to obtain intermediate data; transmitting the intermediate data to the background server; and receiving an execution result of the target service, the execution result being obtained by the background server by executing the target service based on the service data, and the service data being obtained by the background server by decrypting the intermediate data through the service key. In this way, the service key corresponding to the service data is encrypted and decrypted through a root key for transmission, and the service data is also encrypted and transmitted through the service key. As a result, security of the service data in a transmission process can be ensured. In addition, the encryption processing process of the service key is independently run in the encryption protection system, so that the service key can be securely stored and obtained. The encryption protection system does not need to exchange information with the background server. Therefore, configuration is not required for different background servers, which causes an entire data processing process to be applicable to various scenarios.

For ease of understanding, examples of terms involved in this disclosure are briefly explained below. The descriptions of the terms are provided as examples only and are not intended to limit the scope of the disclosure.

White box: An attacker has controlled an entire operation process and can see the process. The attacker can observe a running process of a dynamic password by himself/herself, and detailed content of an internal algorithm is visible and can be changed in various manners.

Black box: Compared with the white box, it may be considered that an attacker does not essentially access a key (executing an encryption or decryption algorithm) or any internal operation, but can only observe some external information or operations. The information includes plaintext (input) or ciphertext (output) in a system, and it is considered that code execution and dynamic encryption cannot be observed.

Obfuscation: this can refer to making a person not understand the information, disturbing the information, making the information exist in a form that cannot be understood, making a person not understand an intermediate process (i.e., only seeing an input and an output, but not understanding how the output is obtained based on the input), but not affecting a function of the information.

Key obfuscation scheme: The key may be stored and written into a code. Through an obfuscator low level virtual machine (OLLVM) technology for the code, a structure of a program becomes more complex and difficult to understand by using control flow flattening, function inlining, variable renaming, constant obfuscation, and code insertion. In this way, the key is protected.

State cryptography library: This can refer to a software library configured for supporting a cryptographic algorithm and a protocol released by the State Cryptography Administration. The state cryptography library usually includes implementation of cryptographic algorithms such as a symmetric encryption algorithm, an asymmetric encryption algorithm, a hash algorithm, and a digital signature algorithm, and corresponding key management and protocol implementation.

SM4: SM4 may include a symmetric encryption algorithm, which is also referred to as SMS4, and is a block cipher algorithm put forward by Chinese cryptologists. The SM4 algorithm adopts a 128-bit key and has a block length of 128 bits, and may be applied to aspects such as data encryption and authentication.

White-box encryption: This can refer to symmetric encryption, and refers to a special encryption method that can defend against an attack in a white-box environment. A core idea is to obfuscate a symmetric key in white-box logic, so that the symmetric key cannot be guessed.

LLVM: This can refer to an open-source compiler infrastructure and includes a set of modular compiler tools and libraries, which may be configured for constructing a compiler, a debugger, a static analysis tool, and the like. The LLVM has become an independent open-source item, and has been widely applied and supported.

OLLVM: This can refer to an obfuscator-LLVM, and is an obfuscation scheme based on an LLVM compiler, and can obfuscate a C/C++ code, thereby increasing complexity and difficulty in understanding of the code and improving security of the code.

TEE: This can refer to a trusted execution environment. TEE is a running environment existing parallel to a Rich OS (usually Android and the like) on a device, and provides security services for the Rich OS. The TEE has its own execution space, and has a higher security level than that of the Rich OS.

Secure element (SE): This can refer to an independent security hardware. Because the security hardware is an independent security hardware chip, security strength is higher than that of the TEE.

JAVA layer and Native layer: The Android JAVA layer can refer to a JAVA code that is run based on a virtual machine (VM), and the Android Native layer refers to a C/C++ code that is run based on a local code.

Key encryption: This can include an encryption method in which two parties transmitting data and receiving data perform an encryption operation on plaintext through the same or symmetric key, and is an encryption service provided for ensuring security of network transmission in an open environment. In this disclosure, various encryption operations are involved, and a difference mainly lies in that keys used for encryption may be different.

For example, the keys used in the following two key encryptions: encrypting a service key through a first root key to generate an encryption key, and encrypting service data through the service key to obtain intermediate data. The main difference lies in that a key used in the first key encryption is the first root key, and a key used in the second key encryption is the service key.

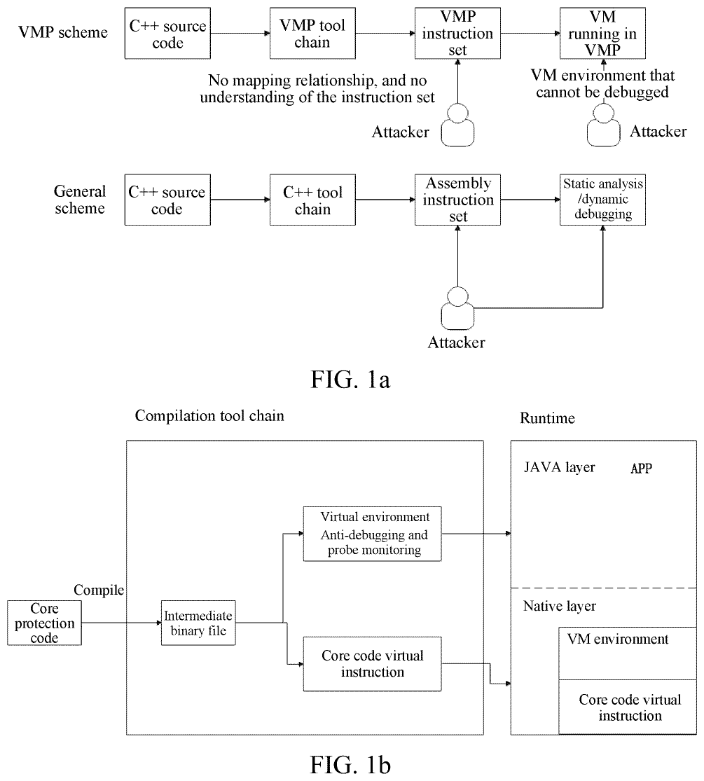

Virtual machine protector (VMP): This may convert part of code in a protected file into a program (bytecode) running on a VM, which is not public to an instruction code in the VM, increasing reverse difficulty. From the perspective of an attacker, an operating principle thereof may be shown in FIG. 1a. In a VMP scheme, a C++ source code is recompiled through a VMP tool chain, to generate a VMP instruction set, and finally, the VMP instruction set is run in the VM of the VMP. Compared with a general assembly instruction set scheme, from the perspective of an attacker, a mapping relationship does not exist in a VMP instruction set generated by compiling based on a VMP tool chain, and the attacker cannot understand the VMP instruction set. In addition, the attacker cannot debug a VM environment. Therefore, a corresponding attack parameter cannot be obtained through debugging.

A running flowchart of the VMP may be as shown in FIG. 1b. A core protection code is obtained through C++ compiling, and the core protection code is first compiled through a VMP compilation toolbox to generate an intermediate binary file. Then, some codes in the intermediate binary file are selected to compile again to generate a core code virtual instruction of the core protection code, a VM environment is created at the same time, and anti-debugging and probe monitoring of the core protection code are performed in the VM environment. Then, the foregoing VM environment (i.e., the encryption protection system of this disclosure) is deployed on the terminal device (the terminal device is configured to execute the service code of the target service). When the terminal device runs the service code, the VM environment on the native layer of the terminal device is called to execute a core code virtual instruction related to the service code.

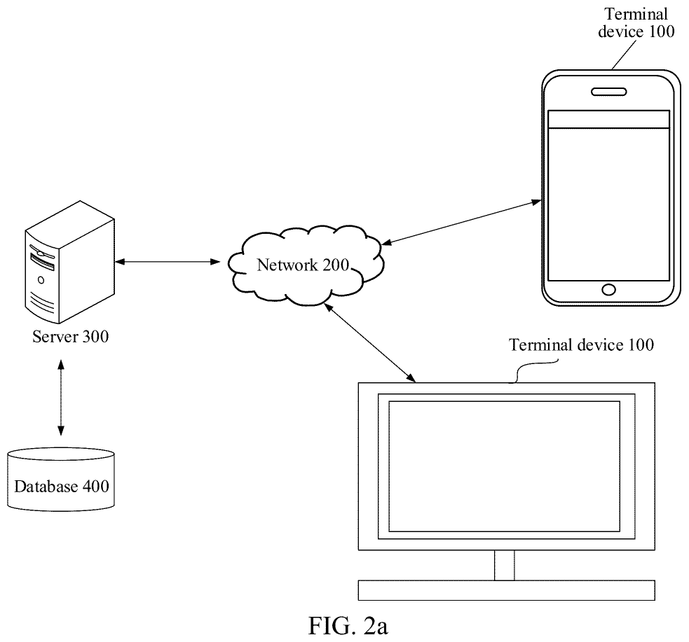

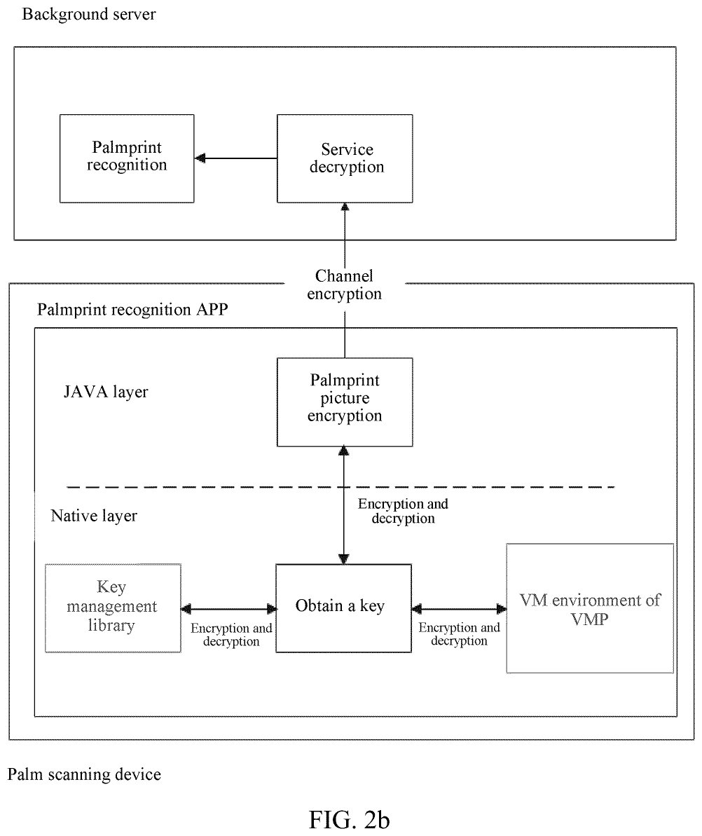

A data processing method and apparatus, a device, and a storage medium provided in the aspects of this disclosure can securely and universally implement service data processing. FIG. 2a is a schematic architectural diagram of an example application scenario of a data processing method according to an aspect of this disclosure. To support a data processing scheme, a terminal device 100 is connected to a server 300 through a network 200, the server 300 is connected to a database 400, and the network 200 may be a wide area network or a local area network, or a combination thereof. A client where a user implements the data processing scheme is deployed on the terminal device 100. The client may run on the terminal device 100 in a form of a browser, or may run on the terminal device 100 in a form of an independent application (APP). A specific presentation form of the client is not limited herein.

The server 300 involved in this disclosure may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform. The terminal device 100 may be a smart phone, a tablet computer, a notebook computer, a palmtop computer, a personal computer, a smart television, a smart watch, an onboard device, a wearable device, and the like, which is not limited thereto.

The terminal device 100 and the server 300 may be directly or indirectly connected through the network 200 through wired or wireless communication, which is not limited in this disclosure. A quantity of the server 300 and a quantity of the terminal device 100 are not limited either. The solution provided in this disclosure may be performed independently by the terminal device 100, may be performed independently by the server 300, or may be performed by both the terminal device 100 and the server 300, which is not limited in this disclosure.

The database 400 may be simply regarded as an electronic file cabinet, namely, a place in which an electronic file is stored. A user may perform an operation such as adding, querying, updating, or deleting data in a file. The so-called “database” is a data set that is stored together in a certain manner, can be shared with a plurality of users, has as little redundancy as possible, and is independent of an APP. A database management system (DBMS) is a computer software system designed to manage databases, and may have basic functions such as storage, interception, security, and backup. The DBMS may be classified based on database models the DBMS supports, for example, a relation or an extensible markup language (XML); or may be classified based on computer types the DBMS supports, for example, a server cluster or a mobile phone; or may be classified based on a query language used in the DBMS, for example, a structured query language (SQL) or XQuery; or may be classified based on key performance metrics, for example, a maximum scale or a highest running speed; or may be classified in other classification manners. Regardless of the classification manner that is used, some DBMSs can cover a plurality of categories, for example, support a plurality of query languages. In this disclosure, the database 400 may be configured to store a key and service data. Certainly, storage locations of the key and the service data is not limited to the database. For example, the key and the service data can further be stored in the terminal device 100, a blockchain, or a distributed file system of the server 300.

Based on the above, a data processing method provided in this disclosure is described below based on an interactive system of an application scenario shown in FIG. 2b.

As shown in FIG. 2b, the application scenario includes a terminal device (shown by using a palm-scanning device as an example) and a background server. A palmprint recognition APP is deployed on the terminal device. The background server is configured to perform a palmprint recognition process (also referred to as palm-scanning recognition). A process of obtaining a palmprint picture and encrypting the palmprint picture are performed on a JAVA layer of the terminal device. A key management library and a VM environment (i.e., the encryption protection system of this disclosure) of a VMP are deployed on a native layer of the terminal device. The key management library may manage a service key that corresponds to the palmprint recognition service. The VM environment of the VMP is configured for performing encryption and decryption of the service key, and the VM environment of the VMP stores a root key that corresponds to the palmprint recognition service. The background server transmits the service key to the terminal device through a transmission interface, and the service key is derived by the background server based on the root key stored in the background server. In addition, the terminal device transmits the palmprint picture encrypted based on the service key to the background server. Then, the background server decrypts the encrypted palmprint picture through the service key to obtain an original palmprint picture, and finally, performs palmprint recognition on the original palmprint picture to obtain a recognition result.

A specific implementation of this disclosure relates to related data such as service data.

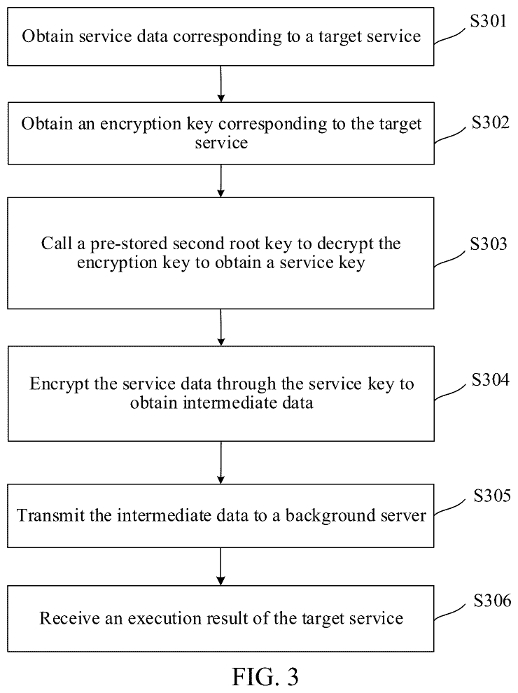

The data processing method in this disclosure is described below in combination with the above introduction. Referring to FIG. 3, an aspect of a data processing method in this aspect of this disclosure includes the following operations.

301: Obtain service data corresponding to a target service.

In this disclosure, the terminal device obtains the service data corresponding to the target service in response to a trigger event of the target service.

For example, in a solution, the target service may be an identity recognition scenario. Identity recognition is an authentication process of recognizing whether a real identity of a user conforms to an identity that the user claims. With the development of identity recognition technologies, a biological feature-based identity recognition manner is widely used. An identity recognition trigger event refers to an event that triggers identity recognition, and may specifically include, but is not limited to, an operation or an instruction that triggers identity recognition. For example, in a scenario of an access control system, an identity recognition event is triggered when a user needs to pass an access control. For another example, an identity recognition event is triggered when a user performs payment on a payment terminal. In addition, the identity recognition may also be applied to an anti-addiction system scenario. For example, in an online game anti-addiction system, online game time of a juvenile needs to be limited. When anti-addiction is triggered, for example, when an accumulated time length of a game user online reaches a preset time length threshold, the identity recognition needs to be performed on the game user. In this case, an identity recognition event is triggered to determine whether the game user is an adult, or whether the game user is a player of a game account, thereby limiting online game time of the juvenile. During specific implementation, the identity recognition trigger event is an event of triggering identity recognition through a biological feature. The biological feature includes a biometric feature for example. The biological feature is a biological feature of a body part of a user that can be measured, for example, various types of biological features such as a hand shape, a fingerprint, a face shape, an iris, a retina, and a palm. When identity recognition processing is performed through biological features of a measurable body part of a user, biological data needs to be collected for the body part of the user, and biological features need to be extracted for the collected biological data, so as to perform identity recognition for the user based on the extracted biological features. For example, if the identity recognition trigger event is triggering to perform identity recognition through a face, the terminal needs to collect face data of the face of the user, and perform identity recognition on the user based on collected face data such as a face image. For another example, if the identity recognition trigger event is triggering to perform identity recognition through a palm, the terminal needs to collect palm data for the palm of the user, and perform identity recognition on the user based on the collected palm data.

In this process, the user corresponding to the target service refers to a user whose identity needs to be recognized, and may specifically be a user triggering the identity recognition event. For example, when the user passes through the access control system, the user may enter a data collection area of the access control system. In the data collection area, when the access control system detects that the user exists, the identity recognition needs to be performed, and the identity recognition is triggered. The access control system collects the biological data of the target user in the data collection area, for example, collects various biological data such as face data, finger data, or palm data of a target user. The service data may be biological data corresponding to a target part of the user corresponding to the target service. In this case, the target part is a part of a human body corresponding to the biological data collection, and the target part is related to the biological data or biological features involved in the identity recognition. For example, if the identity recognition is face-based identity recognition, the corresponding target part is a face part of the target user on which the identity recognition needs to be performed, the collected biological data (i.e., the service data) is the face data, and the biological feature configured for user recognition is a face feature. For another example, if the identity recognition is palm-based identity recognition, the corresponding target part is a palm part of the target user on which the identity recognition needs to be performed, the collected biological data (i.e., the service data) is the palm data, and the biological feature configured for the user recognition is a palm feature.

The service data may be single biological feature data or biological feature combination data. In addition, the service data may be complete biological feature data, or may be biological feature data with partial feature hiding or deformation.

The single biological feature data may be a single type of biological feature. For example, when the target part corresponding to the service data is a face, the single biological feature data is a single type of face feature in the face part, such as a skeletal feature, a texture feature, a geometrical feature, or a representation feature. The type of the face feature is determined based on face features involved in face-based identity recognition processing.

The biological feature combination is a combination of at least two types of biological features at a target part corresponding to the service data. The biological feature combination is obtained by combining different types of biological features, and specifically, is obtained by combining at least two types of biological features. The type of the biological feature in the biological feature combination corresponds to the part type of the target part. For example, when the target part is a face, the biological features in the biological feature combination are various types of face features in the face part, such as a skeletal feature, a texture feature, a geometrical feature, and a representation feature. The type of the face feature is determined based on facial features involved in face-based identity recognition processing. In a specific application, if the face features are obtained by means of different face feature extraction manners, for example, by means of performing feature extraction on a face image through different face recognition models, the biological feature combination may be obtained by combining face features obtained by means of extraction through different face feature extraction manners. For another example, when the target part is a palm, the biological features in the biological feature combination are various types of palm features in the palm part, such as a palmprint feature and a palm vein feature. The biological feature combination is obtained by combining different types of biological features. When the various types of biological features are combined, an equivalent combination may be performed between the biological features. In other words, the biological feature combination is directly obtained based on the various types of biological features. Weighted combination may also be performed on the various types of biological features. In other words, corresponding combination weights are allocated to the various types of biological features, so as to perform weighted combination on the various types of biological features, thereby further ensuring effectiveness of the biological feature combination. During specific implementation, combined weights corresponding to the various types of biological features may be determined based on historical recognition results corresponding to the various biological features, to highlight important biological features in the biological feature combination.

The biological feature data with the local feature hidden or deformed refers to that the form of the target part of the user corresponding to the target service is changed, so as to locally hide a global part of the target part, thereby hiding the biological data of a part of the target part, avoiding leakage of the global biological feature of the target part in a biological feature collection process of identity recognition, and ensuring security of the global biological feature of the target part. Local hiding of the target part may be implemented flexibly based on an actual requirement. For example, in addition to directly performing local physical hiding on the target part, the target part may further be deformed, so as to locally hide a global biological feature of the target part. For example, the target part may be deformed based on flexibility of the target part, an application scenario of identity recognition, and the like, so that the target part is in a locally hidden deformation form. For example, when the target part is a face, the face of the user may be partially blocked. For example, a particular part of the face of the user is blocked through an external blocking object, to block some areas of the face. The user may further control the face to perform form transformation, for example, make specific expressions, so that the face is in a partially hidden deformation form, and partial face features of the face are hidden. For another example, when the target part is a palm, considering that the palm part may be flexibly transformed through fingers, different gestures or hand forms may be made through the fingers, to block or deform the palm, so that the palm is in a deformed form in which the palm is partially hidden. Specifically, the palm may make an “OK” gesture through the index finger and the thumb, and biological features of the index finger and the thumb in the palm may be hidden, so that complete biological features in the palm may be partially hidden. When the target part is in different locally hidden deformation forms, different locally hidden biological features can be collected when biological features are collected for the target part. Identity recognition is performed through the different locally hidden biological features, so that leakage of the global biological features of the target part can be effectively prevented.

The foregoing descriptions are all descriptions of a case in which the identity recognition is implemented through the biological features. In an actual application, in an identity recognition scenario, the service data may alternatively be a recognition password or another recognition information entered by a user, such as a digital certificate or a dynamic password.

The target service may alternatively be another application scenario, such as a data encryption and transmission scenario or an account encryption scenario in a blockchain scenario, which is not specifically limited herein.

302: Obtain an encryption key corresponding to the target service.

The encryption key is generated by a background server of the target service by encrypting a service key through a pre-stored first root key, the service key being dynamically generated by the background server. In an example, the encryption key is generated by a server of the target service by encrypting a dynamically generated service key based on a pre-stored first root key.

The dynamic generation mentioned herein means that the service key is not fixed relative to the target service, but may be generated in real time based on the processing requirement of the service data, thereby improving security. In other words, each time the service data is processed, the service key dynamically generated for the target service may be re-obtained from the background server, and the service key generated each time may be different. For processing of the service data corresponding to the target service, service keys obtained from the background server may also be different for different terminal devices. A manner of dynamically generating the service key may be random generation, thereby ensuring flexibility. In one aspect, the service key is dynamically generated each time a terminal device initiates a service request, ensuring that identical service data transmitted at different times or from different devices uses distinct encryption keys.

After the terminal device responds to the target service, the terminal device may initialize the service key of the target service, namely, call the encryption key corresponding to the target service.

In a possible implementation, the terminal device may store the encryption key through a key management library deployed thereon. In this aspect, the key management library is configured for managing service keys corresponding to individual services. To ensure security of the service keys, the service keys are usually encrypted and then stored. In addition, to ensure a mapping relationship between the service key and the service, a service identifier and the service key are usually mapped and managed. In other words, the service identifier is used as an index between the service and the service key.

In an example solution, the following process may be used when the terminal device calls the encryption key in the key management library.

The terminal device transmits an initialization key request to the key management library. In this case, the initialization key request carries the service identifier of the target service. Then, the encryption key is obtained from the key management library based on the service identifier.

In a possible implementation, “the encryption key is obtained from the key management library based on the service identifier” may include the following. The key management library is traversed and retrieved based on the service identifier to obtain a retrieval result. When the retrieval result indicates that the encryption key corresponding to the target service exists in the key management library, the encryption key is directly called from the key management library. If the retrieval result indicates that the encryption key corresponding to the target service does not exist in the key management library, the terminal device triggers an operation of transmitting a key request to the background server corresponding to the target service. Then, the terminal device receives the encryption key transmitted by the background server, and stores the encryption key in the key management library. Finally, the terminal device calls the encryption key from the key management library.

A service key (stored in an encrypted state) corresponding to each service is stored through a dedicated key management library, so that key security can be effectively improved. Moreover, when the encryption key of the target service is not stored in the key management library, the encryption key obtained through encryption based on the first root key is obtained from the background server. Not only the service key in the transmission process is in the encrypted state, but the terminal device may further complete decryption through the second root key that is symmetric to the first root key. In this way, before the service key is used, the security of the service key is ensured.

In this aspect, after receiving the key request, the background server derives a service key of the target service based on a pre-stored first root key, and then encrypts the service key through the first root key to obtain the encryption key, so that the service key is dynamically generated, and can be flexibly replaced at any time. The background server may encrypt the service key through any one of a symmetric encryption algorithm, an asymmetric encryption algorithm, a hash algorithm, and a digital signature algorithm, which is not specifically limited herein.

In this aspect, the background server and the terminal device both store a fixed root key. The background server may store the first root key in a key storage area of the background server, and the terminal device may store a second root key that is symmetric key with the first root key in an encryption protection system. The key storage area in the background server may be a TEE or an SE, or may be an encryption protection system involved in this disclosure, which is not specifically limited herein.

In one aspect, to further ensure security of the service key of the target service, the terminal device may further use a code obfuscation technology such as an OLLVM technology or a wxprotector technology when calling the key management library to store and call the encryption key, which is not specifically limited herein. The terminal device may perform obfuscation processing on the code related to the service key through the code obfuscation technology, to further enhance cracking difficulty.

The code related to the service key may include a storage code configured for storing the encryption key and a calling code configured for calling the encryption key. Obfuscation processing may be performed on the storage code through a code obfuscation technology, to obtain an obfuscated storage code. The obfuscation processing may be performed on the calling code through the code obfuscation technology, to obtain an obfuscated calling code. For example, the storage code may include instructions for saving the encryption key in the key management library, and the calling code may include instructions for retrieving the encryption key. Both types of code can be independently obfuscated using technologies such as OLLVM or wxprotector, thereby protecting both storage and retrieval operations of sensitive keys.

An attacker cannot understand a process of processing an original code (for example, the storage code and the calling code) into the obfuscated code (for example, the obfuscated storage code and the obfuscated calling code) through the code obfuscation technology. The terminal device knows which code obfuscation technology is used, and a correct function may be correctly restored or implemented when the code is called. For example, the encryption key is stored in the key management library through the obfuscated storage code, or the encryption key is called from the key management library through the obfuscated calling code. In other words, an actual function of the original code is not affected.

Therefore, through the code obfuscation technology, a code structure for storing and calling the encryption key is more complex and difficult to understand, thereby further protecting the encryption key.

303: Call a pre-stored second root key to decrypt the encryption key to obtain the service key. In an example, based on a pre-stored second root key, the encryption key is decrypted to obtain the service key. The first root key and the second root key form a set of symmetric keys.

The first root key and the second root key are a set of symmetric keys. Symmetric key encryption is also referred to as private key encryption or shared key encryption. In other words, two parties transmitting and receiving data use the same key to perform encryption and decryption operations on plaintext. In this disclosure, the terminal device and the background server belong to the two parties involved in the symmetric key encryption, and the first root key and the second root key belong to the same key applied in the symmetric key encryption.

After the terminal device obtains the encryption key by calling the key management library, the terminal device may call the pre-stored second root key to perform decryption on the encryption key through the same encryption algorithm of the background, to obtain the service key corresponding to the target service.

In a possible implementation, the second root key may be stored in an encryption protection system having a relatively high security level. In this aspect, the encryption protection system may be implemented based on a VMP system, for example, a VM system of the VMP, or may be implemented based on a white-box encryption system, which is not specifically limited herein. For example, each may be configured to securely perform encryption and decryption operations involving the root key and service key.

The white-box encryption system uses symmetric encryption and belongs to a special encryption method that can defend against an attack in a white-box environment. A core idea is to obfuscate the symmetric key in white-box logic, so that the attacker cannot guess. A VMP system can convert some codes in a protected encryption key into a program (bytecode) that runs on the VM, and an instruction code in the VM is not made public, thereby increasing reverse difficulty. Either type may provide a secure decryption environment for the encryption key, to protect the service key obtained through decryption from being obtained by the attacker. In addition, the second root key can also be effectively protected.

304: Encrypt the service data through the service key to obtain intermediate data. In an example, the service data is encrypted based on the service key to generate intermediate data.

The terminal device performs encryption processing on the service data after obtaining the service key, to obtain intermediate data configured for channel transmission.

The terminal device may encrypt the service data through any one of a symmetric encryption algorithm, an asymmetric encryption algorithm, a hash algorithm, and a digital signature algorithm, which is not specifically limited herein.

The symmetric encryption algorithm is an encryption algorithm applied earlier, which has a mature technology. In the symmetric encryption algorithm, after a data transmitter jointly performs special encryption algorithm processing on a plaintext (original data) and an encryption key (a secret key), the plaintext becomes a complex encrypted ciphertext and transmits out the complex encrypted ciphertext. After receiving the ciphertext, the receiver needs to decrypt the ciphertext through a key configured for encryption and an inversion algorithm of the same algorithm if the original text needs to be interpreted, so that the ciphertext can be restored to a readable plaintext. In the symmetric encryption algorithm, only one key used exists. Both the transmitter and the receiver encrypt and decrypt data through the key, which requires that a decrypting party needs to know the encryption key in advance.

The asymmetric encryption algorithm, which is also referred to as public key encryption, belongs to a secondary subject of network security under communications technologies, and refers to an encryption method including a corresponding pair of uniqueness keys (i.e., a public key and a private key). The algorithm resolves a problem of key issuance and management, and is a core of a commercial password. In a public key encryption system, the private key is not made public, and the public key is made public.

If the terminal device performs encryption through the asymmetric encryption algorithm to obtain the intermediate data, in addition to the service key, the terminal device further needs to use the private key of the terminal device. Further, the background server further needs to cooperate with the public key of the terminal device during decryption.

In this aspect, the terminal device may call the encryption protection system to encrypt the service data. Alternatively, the service data may be encrypted in a local environment of the terminal device.

In an example solution, as shown in FIG. 2b, the terminal device calls the VM environment of the VMP to encrypt the service data, or the terminal device encrypts the service data at the JAVA layer.

As described above, the encryption protection system or the key management library belongs to a more secure running environment. Encrypting the service data in this type of environment can effectively protect the security of the service data before or during the encryption.

305: Transmit the intermediate data to the background server. In an example, the intermediate data is transmitted to the server.

The terminal device transmits the intermediate data to the background server in a wired or wireless manner.

The terminal device may also encrypt the transmission channel when transmitting the intermediate data, which is not specifically limited herein.

306: Receive an execution result of the target service. In an example, an execution result generated by the server based on the service data is received, The server decrypts the intermediate data based on the service key to obtain the service data.

The execution result is obtained by the background server by executing the target service based on the service data, and the service data is obtained by the background server by decrypting the intermediate data through the service key. Because the service data is related to the target service, the execution result of the service data corresponding to the target service can be obtained by executing the target service through the service data.

The terminal device receives the execution result fed back by the background server, and displays the execution result to the user.

In this aspect, after receiving the intermediate data, the background server performs decryption on the intermediate data based on the pre-stored service key to obtain the service data, and then executes the target service based on the service data, to obtain the execution result corresponding to the target service.

In the obtaining service data corresponding to a target service in S301, the service data may be different based on different target services. In a possible implementation, the method includes:
obtaining a palmprint picture in a palmprint recognition service, and using the palmprint picture as the service data;
or
obtaining a fingerprint picture in a fingerprint recognition service, and using the fingerprint picture as the service data;
or
obtaining an iris picture in an iris recognition service, and using the iris picture as the service data;
or
obtaining voice data in a voice recognition service, and using the voice data as the service data;
or
obtaining a face picture in a face recognition service, and using the face picture as the service data.

Correspondingly, an execution result in S306 may also be different with different target services and service data. In a possible implementation,
when the palmprint picture is used as the service data, the execution result is obtained by the background server by performing the palmprint recognition service based on the palmprint picture;
or
when the fingerprint picture is used as the service data, the execution result is obtained by the background server by performing a fingerprint recognition service based on the fingerprint picture;
or
when the iris picture is used as the service data, the execution result is obtained by the background server by performing the iris recognition service based on the iris picture;
or
when the voice data is used as the service data, the execution result is obtained by the background server by performing the voice recognition service based on the voice data;
or
when the face picture is used as the service data, the execution result is obtained by the background server by performing the face recognition service based on the face picture.

It may be learned that the aspects of this disclosure may be applied to various target services, and provide a secure service processing environment for various target services, to obtain a corresponding execution result.

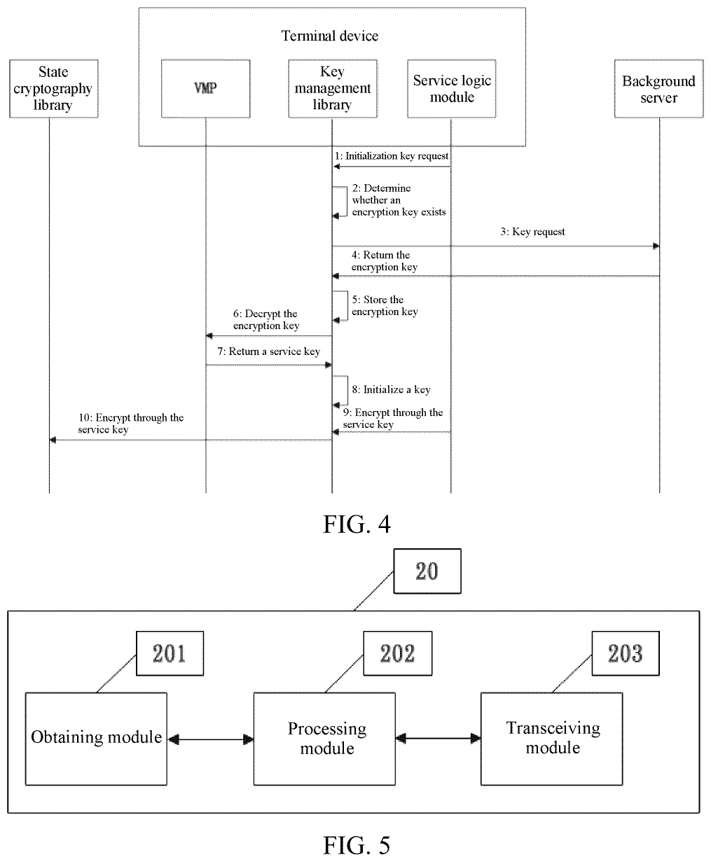

The data processing method is described below through a specific application scenario. As shown in FIG. 4, the application scenario includes a terminal device, a background server, and a state cryptography library. A VMP, a key management library, and a service logic module are deployed in the terminal device. The state cryptography library is configured for maintaining various encryption algorithms. The key management library is configured for managing service keys of various services. The VMP is configured for performing an encryption and decryption process of the service keys. The service logic module is configured to execute a service code of the palmprint recognition service. Based on the foregoing description, a procedure of the palmprint recognition service is described below.

1. The service logic module initiates an initialization key request to the key management library in response to a trigger event of the palmprint recognition service. The initialization key request carries a service identifier of the palmprint recognition service.

2. The key management library determines whether the encryption key corresponding to the palmprint recognition service exists in the key management library based on the service identifier. If no, operation 3 to operation 7 are performed; and if yes, operation 8 is performed.

3. The key management library initiates a key request to the background server.

4. The background server derives a service key of the palmprint recognition service based on the stored root key, and stores the service key. Then, the service key is encrypted through the root key to generate an encryption key, and the encryption key is returned to the key management library.

5. After receiving the encryption key, the key management library stores the encryption key. In this aspect, when storing the encryption key, the key management library associatively stores the encryption key and the service identifier of the palmprint recognition service.

6. The key management library calls the VMP to decrypt the encryption key, to obtain the service key. The VMP and the background server separately store a set of symmetric root keys. Therefore, the key management library may call the VMP to decrypt the encryption key through a pre-stored root key, to obtain the service key.

7. In the VMP virtual environment, a code for decrypting the encryption key through the root key is run by using the virtual environment. A decryption algorithm corresponding to an encryption algorithm by which the background server encrypts the service key is pre-manufactured in the VMP virtual environment. In this way, the state cryptography library may not be relied on, thereby improving security of a decryption process. The service key is returned to the key management library after the service key is obtained through decryption.

8. The key management library performs operation 6 if the encryption key of the palmprint recognition service exists in the key management library.

9. The service logic module calls the service key from the key management library to encrypt the palmprint picture.

10. When operation 9 is performed, the key management library calls a corresponding encryption algorithm from the state cryptography library to encrypt the palmprint picture through the service key. The key management library may directly encrypt or decrypt the service data in the local environment of the terminal device when encrypting the palmprint picture by calling the encryption algorithm of the state cryptography library, so as to accelerate encryption and decryption of the service data.

A data processing apparatus in this disclosure is described in further detail below. FIG. 5 is a schematic diagram of an aspect of a data processing apparatus according to an aspect of this disclosure. A data processing apparatus 20 includes:
an obtaining module 201, configured to obtain service data corresponding to a target service;
a processing module 202, configured to: obtain an encryption key corresponding to the target service, the encryption key being generated by a background server of the target service by encrypting a service key through a pre-stored first root key, the service key being dynamically generated by the background server; call a pre-stored second root key to decrypt the encryption key to obtain the service key, the first root key and the second root key being a set of symmetric keys; and encrypt the service data through the service key to obtain intermediate data; and
a transceiving module 203, configured to transmit the intermediate data to the background server, and receive an execution result of the target service, the execution result being obtained by the background server by executing the target service based on the service data, and the service data being obtained by the background server by decrypting the intermediate data through the service key.

In an aspect of this disclosure, a data processing apparatus is provided. Through the foregoing apparatus, the service key corresponding to the service data is encrypted and decrypted through a root key for transmission, and the service data is also encrypted and transmitted through the service key. As a result, security of the service data in a transmission process can be ensured. In addition, the encryption processing process of the service key is independently run in the encryption protection system, so that the service key can be securely stored and obtained. The encryption protection system does not need to exchange information with the background server. Therefore, configuration is not required for different background servers, which causes an entire data processing process to be applicable to various scenarios.

Based on the aspect corresponding to FIG. 5 above, in another aspect of the data processing apparatus 20 provided in this aspect of this disclosure,
the processing module 202 is configured to: transmit an initialization key request to a key management library, the initialization key request carrying a service identifier of the target service; and
obtain the encryption key from the key management library based on the service identifier.

In an aspect of this disclosure, a data processing apparatus is provided. Through the foregoing apparatus, the key management library is queried, by using the service identifier, for whether the key corresponding to the target service exists. In this way, when the key exists, interaction with a service background can be reduced, thereby increasing a service processing speed.

Based on the aspect corresponding to FIG. 5 above, in another aspect of the data processing apparatus 20 provided in this aspect of this disclosure, the processing module 202 is configured to: traverse and retrieve the key management library based on the service identifier to obtain a retrieval result;
call the encryption key from the key management library when the retrieval result determines that the encryption key is present in the key management library;
transmit a key request to the background server when the retrieval result determines that the encryption key is not present in the key management library, so that the background server generates the service key in response to the key request, and performs encryption processing on the service key through the first root key to obtain the encryption key;
receive the encryption key transmitted by the background server, and store the encryption key in the key management library; and
call the encryption key from the key management library.

In an aspect of this disclosure, a data processing apparatus is provided. Through the foregoing apparatus, when it is determined that the key corresponding to the target service exists in the key management library based on the service identifier, the key corresponding to the target service may be directly called, and when the key does not exist, a service background may be requested to generate the key. In this way, interaction with the service background each time is avoided, thereby increasing a service processing speed.

Based on the aspect corresponding to FIG. 5 above, in another aspect of the data processing apparatus 20 provided in this aspect of this disclosure,
the encryption key is obtained by encrypting the service key through any one of a symmetric encryption algorithm, an asymmetric encryption algorithm, a hash algorithm, and a digital signature algorithm by using the first root key.

In an aspect of this disclosure, a data processing apparatus is provided. Through the foregoing apparatus, a plurality of encryption algorithms are provided to implement the process of encrypting service keys based on the root key. In this way, implementability of the scheme can be improved.

Based on the aspect corresponding to FIG. 5 above, in another aspect of the data processing apparatus 20 provided in this aspect of this disclosure,

The processing module 202 is configured to: perform obfuscation processing on a storage code of the encryption key through a code obfuscation technology, to obtain an obfuscated storage code; and
store the encryption key in the key management library through the obfuscated storage code.

In an aspect of this disclosure, a data processing apparatus is provided. Through the foregoing apparatus, the storage code of the first key is obfuscated by using a plurality of obfuscation technologies, so that security of the first key can be improved.

Based on the aspect corresponding to FIG. 5 above, in another aspect of the data processing apparatus 20 provided in this aspect of this disclosure, the processing module 202 is configured to: perform, through a code obfuscation technology, obfuscation processing on a calling code for calling the encryption key from the key management library, to obtain an obfuscated calling code; and call the encryption key from the key management library through the obfuscated calling code.

In an aspect of this disclosure, a data processing apparatus is provided. Through the foregoing apparatus, the calling code of the first key is obfuscated by using a plurality of obfuscation technologies, so that security of the first key can be improved.

Based on the aspect corresponding to FIG. 5 above, in another aspect of the data processing apparatus 20 provided in this aspect of this disclosure, the processing module 202 is configured to encrypt the service data through any one of the symmetric encryption algorithm, the asymmetric encryption algorithm, the hash algorithm, or the digital signature algorithm by using the service key, to obtain the intermediate data.

In an aspect of this disclosure, a data processing apparatus is provided. Through the foregoing apparatus, the encryption processing of the service data is implemented by using a plurality of encryption methods, and implementability of the scheme can be improved.

Based on the aspect corresponding to FIG. 5 above, in another aspect of the data processing apparatus 20 provided in this aspect of this disclosure,
the processing module 202 is configured to call an encryption protection system to encrypt the service data through any one of the symmetric encryption algorithm, the asymmetric encryption algorithm, the hash algorithm, or the digital signature algorithm by using the service key, to obtain the intermediate data;
or
the processing module 202 is configured to call the key management library to encrypt the service data through any one of the symmetric encryption algorithm, the asymmetric encryption algorithm, the hash algorithm, or the digital signature algorithm by using the service key, to obtain the intermediate data.

In an aspect of this disclosure, a data processing apparatus is provided. Through the foregoing apparatus, an encryption protection system may be called to perform encryption on service data, thereby improving security of the service data. Encryption may also be performed on the service data in a real operation scenario. In this way, an encryption speed of the service data can be accelerated, thereby increasing a service processing speed.

In a possible design, in another implementation of another aspect of the aspects of this disclosure, the obtaining module 201 is configured to obtain a palmprint picture in a palmprint recognition service, and use the palmprint picture as the service data;
or
the obtaining module 201 is configured to obtain a fingerprint picture in a fingerprint recognition service, and use the fingerprint picture as the service data;
or
the obtaining module 201 is configured to obtain an iris picture of an iris recognition service, and use the iris picture as the service data;
or
the obtaining module 201 is configured to obtain voice data in a voice recognition service, and use the voice data as the service data;
or
the obtaining module 201 is configured to obtain a face picture in a face recognition service, and use the face picture as the service data.

In an aspect of this disclosure, a data processing apparatus is provided. Through the foregoing apparatus, multiple application scenarios are refined, and universality and implementability of the scheme can be improved.

Based on the aspect corresponding to FIG. 5 above, in another aspect of the data processing apparatus 20 provided in this aspect of this disclosure,
when the palmprint picture is used as the service data, the execution result is obtained by the background server by performing the palmprint recognition service based on the palmprint picture;
or
when the fingerprint picture is used as the service data, the execution result is obtained by the background server by performing a fingerprint recognition service based on the fingerprint picture;
or
when the iris picture is used as the service data, the execution result is obtained by the background server by performing the iris recognition service based on the iris picture;
or
when the voice data is used as the service data, the execution result is obtained by the background server by performing the voice recognition service based on the voice data;
or
when the face picture is used as the service data, the execution result is obtained by the background server by performing the face recognition service based on the face picture.

In an aspect of this disclosure, a data processing apparatus is provided. Through the foregoing apparatus, multiple application scenarios are refined, and universality and implementability of the scheme can be improved.

Based on the aspect corresponding to FIG. 5 above, in another aspect of the data processing apparatus 20 provided in this aspect of this disclosure,
the processing module 202 is configured to calling a VMP system to decrypt the encryption key through the second root key, to obtain the service key, the VMP system being used as the encryption protection system.

In an aspect of this disclosure, a data processing apparatus is provided. Through the foregoing apparatus, a VMP system is used as the encryption protection system, so that a key encryption and decryption process can be operated in a VM environment, and an attacker cannot learn a specific instruction set of a code, thereby ensuring security of the key, and further improving security of the service data.

Based on the aspect corresponding to FIG. 5 above, in another aspect of the data processing apparatus 20 provided in this aspect of this disclosure,
the processing module 202 is configured to call a white-box encryption system to decrypt the encryption key through the second root key, to obtain the service key, the white-box encryption system being used as the encryption protection system.

In an aspect of this disclosure, a data processing apparatus is provided. Through the foregoing apparatus, white-box encryption is used as the encryption protection system, and keys are obfuscated in logic of the white-box encryption system, so that an attacker cannot obtain a specific operation, thereby improving security of the keys, and further improving security of the service data.

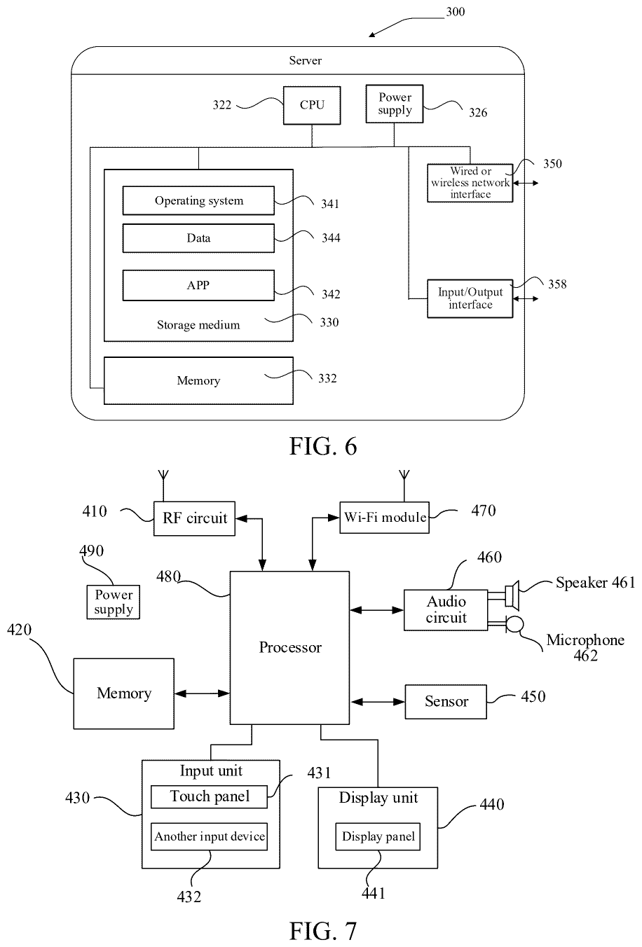

The data processing apparatus provided in this disclosure may be used in a server. FIG. 6 is a schematic structural diagram of a server according to an aspect of this disclosure. A server 300 may vary greatly due to different configurations or performance, and may include one or more central processing units (CPUs) 322 (for example, processing circuitry, such as one or more processors and a memory 332), and one or more storage media 330 (for example, one or more mass storage devices) having an APP 342 or data 344 stored therein. The memory 332 and the storage medium 330 may provide transitory storage or persistent storage. Storage medium 330 may also include a non-transitory computer-readable storage medium. A program stored in the storage medium 330 may include one or more modules (not shown in the figure), and each module may include a series of instruction operations in the server. Further, the CPU 322 may be configured to communicate with the storage medium 330, and perform, on the server 300, a series of instructional operations in the storage medium 330.

The server 300 may further include one or more power supplies 326, one or more wired or wireless network interfaces 350, one or more input/output interfaces 358, and/or one or more operating systems 341, for example, Windows Server™, Mac OS X™, Unix™, Linux™, and FreeBSD™.

The operations performed by the server in the foregoing aspects may be based on the structure of the server shown in FIG. 6.

The data processing apparatus provided in this disclosure may be used in a terminal device. Referring to FIG. 7, for ease of description, only parts related to this aspect of this disclosure are shown. For specific technical details not disclosed, reference can be made to the method part of the aspects of this disclosure. In the aspects of this disclosure, a description is provided by using an example in which the terminal device is a smart phone.

FIG. 7 is a block diagram of a structure of a part of a smart phone related to a terminal device according to an aspect of this disclosure. Referring to FIG. 7, the smart phone includes components such as a radio frequency (RF) circuit 410, a memory 420, an input unit 430, a display unit 440, a sensor 450, an audio circuit 460, a Wi-Fi module 470, a processor 480, and a power supply 490. A person skilled in the art may understand that the structure of the smart phone shown in FIG. 7 does not constitute a limitation on the smart phone, and the smart phone may include more components or fewer components than those shown in the figure, or some merged components, or different component arrangements.

The components of the smart phone are described in detail below with reference to FIG. 7.

The RF circuit 410 may be configured to receive and transmit signals during information receiving and transmission or a call. Specifically, the RF circuit receives downlink information from a base station, and then delivers the downlink information to the processor 480 for processing. In addition, involved uplink data is transmitted to the base station.

The memory 420 may be configured to store a software program and a module, and the processor 480 executes various function applications of the smart phone and performs data processing by running the software program and the module stored in the memory 420.

The input unit 430 may be configured to receive an entered numeral or character information, and generate key signal input related to user setting and function control of the smart phone.

The display unit 440 may be configured to display information inputted by the user or information provided for the user, and various menus of the smart phone.

The smart phone may further include at least one sensor 450, for example, a light sensor, a motion sensor, and another sensor. Specifically, the optical sensor may include an ambient light sensor and a proximity sensor. The ambient light sensor may adjust brightness a display panel 441 based on brightness of the ambient light. The proximity sensor may switch off the display panel 441 and/or backlight when the smart phone is moved to the ear. As one type of motion sensor, an acceleration sensor may detect magnitude of accelerations in various directions (e.g., on three axes), may detect magnitude and a direction of the gravity when being static, and may be applied to an application that recognizes the attitude of the smart phone (for example, switching between landscape orientation and portrait orientation, a related game, and magnetometer attitude calibration), a function related to vibration recognition (such as a pedometer and a knock), and the like. Another sensor, such as a gyroscope, a barometer, a hygrometer, a thermometer, and an infrared sensor, which may be configured in the smart phone, is not further described herein.

The audio circuit 460, a speaker 461, and a microphone 462 may provide audio interfaces between the user and the smart phone.

The operations performed by the terminal device in the foregoing aspects may be based on the structure of the terminal device shown in FIG. 7.

An aspect of this disclosure further provides a computer-readable storage medium, such as a non-transitory computer-readable storage medium, having a computer program stored therein, the computer program, when run on a computer, causing the computer to perform the method described in the foregoing aspects.

An aspect of this disclosure further provides a computer program product including a program, the program, when run on a computer, causing the computer to perform the method described in the foregoing aspects.

A person skilled in the art may understand that, for convenience and conciseness of description, for specific operating processes of the system, the apparatus, and the units described above, reference may be made to the corresponding processes in the foregoing method aspects. Details are not described herein again.

In the several aspects provided in this disclosure, the disclosed system, apparatus, and method may be implemented in other manners. For example, the apparatus aspect described above is merely an example. For example, division into the units is merely logical function division, and may be another division during actual implementation. For example, a plurality of units or components may be combined or integrated into another system, or some features may be ignored or not executed. In addition, the displayed or discussed mutual coupling or direct coupling or communication connection may be implemented through some interfaces. The indirect coupling or communication connection between the apparatuses or units may be implemented in an electronic, mechanical, or another form.

The units described as separate components may or may not be physically separated, and the components displayed as units may or may not be physical units, and may be located in one place or may be distributed over a plurality of network units. Some or all of the units may be selected based on actual demands to achieve the objectives of the solutions of the aspects.

In addition, functional units in the aspects of this disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure may be implemented in a form of a software product. The computer software product is stored in a storage medium, and includes a plurality of instructions for enabling a computer device (which may be a personal computer, a server, a network device, or the like) to perform all or some of the operations of the method in the aspects of this disclosure. The foregoing storage medium includes any medium that can store a program code, such as a USB flash drive, a removable hard disk, a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of foregoing aspects may be combined in different manners to form other aspects. For ease of description, not all possible combinations of the technical features in aspects are described. However, as long as there is no contradiction in the combinations of these technical features, it is to be considered to be within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Based on the above, the foregoing aspects are merely intended to describe the technical solutions of this disclosure, and are not intended to limit this disclosure. Although this disclosure is described with reference to the above aspects, a person of ordinary skill in the art is to understand that modifications may still be made to the technical solutions described in the foregoing aspects, or equivalent replacements may be made to the part of the technical features. However, these modifications or substitutions do not make the essence of the corresponding technical solutions depart from the spirit and scope of the technical solutions in aspects of this disclosure.

What is claimed is:

1. A data processing method, comprising:
obtaining, in response to a trigger event of a target service, service data corresponding to the target service;
obtaining an encryption key corresponding to the target service, the encryption key being generated by a server of the target service by encrypting a dynamically generated service key based on a pre-stored first root key;
decrypting, based on a pre-stored second root key, the encryption key to obtain the service key, wherein the first root key and the second root key form a set of symmetric keys;
encrypting the service data based on the service key to generate intermediate data;
transmitting the intermediate data to the server; and
receiving an execution result generated by the server based on the service data, wherein the server decrypts the intermediate data based on the service key to obtain the service data.

2. The method according to claim 1, wherein the obtaining the encryption key comprises:
transmitting an initialization key request including a service identifier of the target service to a key management library; and
obtaining the encryption key from the key management library based on the service identifier.

3. The method according to claim 2, wherein the obtaining the encryption key from the key management library comprises:
traversing the key management library using the service identifier to obtain a retrieval result;
when the retrieval result indicates that the encryption key is present in the key management library, obtaining the encryption key from the key management library;
when the retrieval result indicates that the encryption key is not present in the key management library, obtaining the encryption key from the key management library after the key management library transmits a key request to the server, receives the encryption key from the server, and stores the encryption key in the key management library.

4. The method according to claim 3, wherein the encryption key is generated by encrypting the service key using one of a symmetric encryption algorithm, an asymmetric encryption algorithm, a hash algorithm, or a digital signature algorithm.

5. The method according to claim 3, wherein the storing the encryption key in the key management library comprises:
performing obfuscation on storage code associated with the encryption key to generate obfuscated storage code; and
storing the encryption key in the key management library based on the obfuscated storage code.

6. The method according to claim 3, wherein the obtaining the encryption key from the key management library comprises:
performing obfuscation on calling code used to retrieve the encryption key to generate obfuscated calling code; and
obtaining the encryption key from the key management library based on the obfuscated calling code.

7. The method according to claim 1, wherein the encrypting the service data comprises:
encrypting the service data using one of a symmetric encryption algorithm, an asymmetric encryption algorithm, a hash algorithm, or a digital signature algorithm.

8. The method according to claim 2, wherein the encrypting the service data comprises:
invoking an encryption protection system to encrypt the service data based on the service key; or
invoking the key management library to encrypt the service data based on the service key.

9. The method according to claim 1, wherein the service data comprises one of:
a palmprint image for palmprint recognition;
a fingerprint image for fingerprint recognition;
an iris image for iris recognition;
voice data for voice recognition; or
a face image for face recognition.

10. The method according to claim 9, wherein the execution result comprises:
a palmprint recognition result based on the palmprint image;
a fingerprint recognition result based on the fingerprint image;
an iris recognition result based on the iris image;
a voice recognition result based on the voice data; or
a face recognition result based on the face image.

11. The method according to claim 1, wherein the decrypting the encryption key comprises:
invoking a virtual machine protection (VMP) system to decrypt the encryption key using the second root key.

12. The method according to claim 1, wherein the decrypting the encryption key comprises:
invoking a white-box encryption system to decrypt the encryption key using the second root key.

13. A data processing apparatus, comprising:
processing circuitry configured to:
obtain, in response to a trigger event of a target service, service data corresponding to the target service;
obtain an encryption key corresponding to the target service, the encryption key being generated by a server of the target service by encrypting a dynamically generated service key based on a pre-stored first root key;
decrypt, based on a pre-stored second root key, the encryption key to obtain the service key, wherein the first root key and the second root key form a set of symmetric keys;
encrypt the service data based on the service key to generate intermediate data;
transmit the intermediate data to the server; and
receive an execution result generated by the server based on the service data, wherein the server decrypts the intermediate data based on the service key to obtain the service data.

14. The data processing apparatus according to claim 13, wherein the processing circuitry is configured to:
transmit an initialization key request including a service identifier of the target service to a key management library; and
obtain the encryption key from the key management library based on the service identifier.

15. The data processing apparatus according to claim 14, wherein the processing circuitry is configured to:
traverse the key management library using the service identifier to obtain a retrieval result;
when the retrieval result indicates that the encryption key is present in the key management library, obtain the encryption key from the key management library;
when the retrieval result indicates that the encryption key is not present in the key management library, obtain the encryption key from the key management library after the key management library transmits a key request to the server, receives the encryption key from the server, and stores the encryption key in the key management library.

16. The data processing apparatus according to claim 15, wherein the encryption key is generated by encrypting the service key using one of a symmetric encryption algorithm, an asymmetric encryption algorithm, a hash algorithm, or a digital signature algorithm.

17. The data processing apparatus according to claim 15, wherein the processing circuitry is configured to:
perform obfuscation on storage code associated with the encryption key to generate obfuscated storage code; and
store the encryption key in the key management library based on the obfuscated storage code.

18. The data processing apparatus according to claim 15, wherein the processing circuitry is configured to:
perform obfuscation on calling code used to retrieve the encryption key to generate obfuscated calling code; and
obtain the encryption key from the key management library based on the obfuscated calling code.

19. The data processing apparatus according to claim 13, wherein the processing circuitry is configured to:
encrypt the service data using one of a symmetric encryption algorithm, an asymmetric encryption algorithm, a hash algorithm, or a digital signature algorithm.

20. A non-transitory computer-readable storage medium, storing instructions which when executed by a processor cause the processor to perform:
obtaining, in response to a trigger event of a target service, service data corresponding to the target service;
obtaining an encryption key corresponding to the target service, the encryption key being generated by a server of the target service by encrypting a dynamically generated service key based on a pre-stored first root key;
decrypting, based on a pre-stored second root key, the encryption key to obtain the service key, wherein the first root key and the second root key form a set of symmetric keys;
encrypting the service data based on the service key to generate intermediate data;
transmitting the intermediate data to the server; and
receiving an execution result generated by the server based on the service data, wherein the server decrypts the intermediate data based on the service key to obtain the service data.
